(19) United States
(12) Patent Application Publication
(10) Pub. No.: US 2007/0028105 A1
(43) Pub. Date: Feb. 1, 2007

(54) Apparatus and method for providing security in computing and communication environments

(76) Inventor: Michael S. Hynek, Dallas, TX (US)

Correspondence Address: DOCKET CLERK, P.O. DRAWER 800889, DALLAS, TX, 75380, US

(21) Appl. No.: 11/454,150

(22) Filed: Jun. 15, 2006

Related U.S. Application Data
(60) Provisional application No. 60/690,687, filed on Jun. 15, 2005.

(51) Int. Cl. H04L 9/00

(52) U.S. Cl. 713/170; 713/155

(57) ABSTRACT

A computing or communication system may provide an “issued back” password to a user who is authorized to access the computing or communication system. The issued back password may be used by the user to verify that communications with the computing or communication system are legitimate. For example, the issued back password could be included in electronic mail or text messages originating from the computing or communication system or an entity associated with the computing or communication system. The issued back password could also be provided to the user when the user is logging into the computing or communication system. In another technique, biometric, photographic, audio, video, or graphical information is provided to a computing or communication system by a user during authentication.

### CROSS-REFERENCE TO RELATED APPLICATIONS

This application claims priority under 35 U.S.C. § 119(e) to U.S. Patent Application No. 60/690,687 filed on Jun. 15, 2005, which is hereby incorporated by reference.

### TECHNICAL FIELD

This disclosure relates generally to security systems and more specifically to an apparatus and method for providing security in computing and communication environments.

### BACKGROUND

Many attempts have been made to provide security and limit access to different computing systems. A very typical and wide-spread security mechanism involves assigning usernames and passwords to people who are authorized to access a computing system. A user who provides a suitable username/password combination can then gain access to the computing system. A problem with this approach is that the authentication process only works in one direction. In most cases, the computing system may verify that the user is authorized, but the user may not be certain that the computing system is authentic. Another problem is that usernames and passwords can be stolen quite easily. An unscrupulous person may be able to impersonate a legitimate computing system and communicate with a user to further unscrupulous activity. This could also allow an unauthorized person to access and use a computing system inappropriately.

Common techniques used to steal usernames and passwords include “phishing,” “pharming,” and “evil twins.” “Phishing” typically involves sending fraudulent electronic mail (email) to various recipients, asking the recipients to divulge personal, financial, or account information (including usernames and passwords). “Phishing” is often used in combination with “spoofing,” which typically involves making a fraudulent email appear as if it originated from a valid source. “Pharming” typically involves misdirecting users to fraudulent websites, even if a user types a correct web address in a web browser. The users may then provide the fraudulent websites with their usernames and passwords. An “evil twin” typically represents a wireless network that impersonates a legitimate wireless network accessed by portable computers, handheld devices (such as mobile telephones or personal digital assistants), or any other devices that communicate or access a network over a connection. The users, believing they are accessing a legitimate network, then often provide usernames and passwords to the imposter network.

### SUMMARY

This disclosure provides an apparatus and method for providing security in computing and communication environments. In general, users and computing or communication systems are able to verify that they are communicating with a proper counterpart. This may facilitate actions such as gaining physical access to or from a location, gaining access to or from a computing or communication system or network, making or receiving a payment, making a purchase or sale, or communicating in any other manner.

In a first embodiment, a method includes receiving an issued back password from a computing or communication system. The method also includes using the issued back password to verify a communication with the computing or communication system. Using the issued back password to verify the communication could include receiving a message (such as an electronic mail message or text message) that appears to originate with the computing or communication system and/or an entity associated with the computing or communication system and verifying whether the message contains the issued back password. Using the issued back password to verify the communication could also include attempting to log into the computing or communication system and verifying whether the issued back password is received from the computing or communication system during the login process.

In a second embodiment, a method includes storing authentication information associated with a user of a computing or communication system, where the authentication information includes an issued back password. The method also includes transmitting a communication to a computing or communication device used by the user, where the communication includes the issued back password. The communication could represent a message (such as an electronic mail message or text message), and the issued back password in the message may facilitate verification by the user that the message originated with the computing or communication system and/or an entity associated with the computing or communication system. The communication could also represent one or more web pages, and the issued back password in the one or more web pages facilitates verification by the user that the one or more web pages originated with the computing or communication system.

In a third embodiment, a method includes providing authentication information to a computing or communication system, where the authentication information includes a username and password. The method also includes receiving an issued back password from the computing or communication system and verifying whether the issued back password matches an expected issued back password. In addition, the method includes providing additional authentication information to the computing or communication system if the issued back password matches the expected issued back password.

In a fourth embodiment, a method includes providing at least one of biometric information, photographic information, audio information, video information, and graphical information to a computing or communication system over a network to gain access to the computing or communication system.

Other technical features may be readily apparent to one skilled in the art from the following figures, descriptions, and claims.

### BRIEF DESCRIPTION OF DRAWINGS

For a more complete understanding of this disclosure, reference is now made to the following description, taken in conjunction with the accompanying drawings, in which:

FIG. 1 illustrates an example computing or communication environment according to one embodiment of this disclosure;

FIG. 2 illustrates an example issued back password table according to one embodiment of this disclosure;

FIG. 3 illustrates an example method for providing security using issued back passwords according to one embodiment of this disclosure; and

FIG. 4 illustrates an example method for providing security using biometric, photographic, audio, video, or graphical security information according to one embodiment of this disclosure.

### DETAILED DESCRIPTION OF EXAMPLE EMBODIMENTS

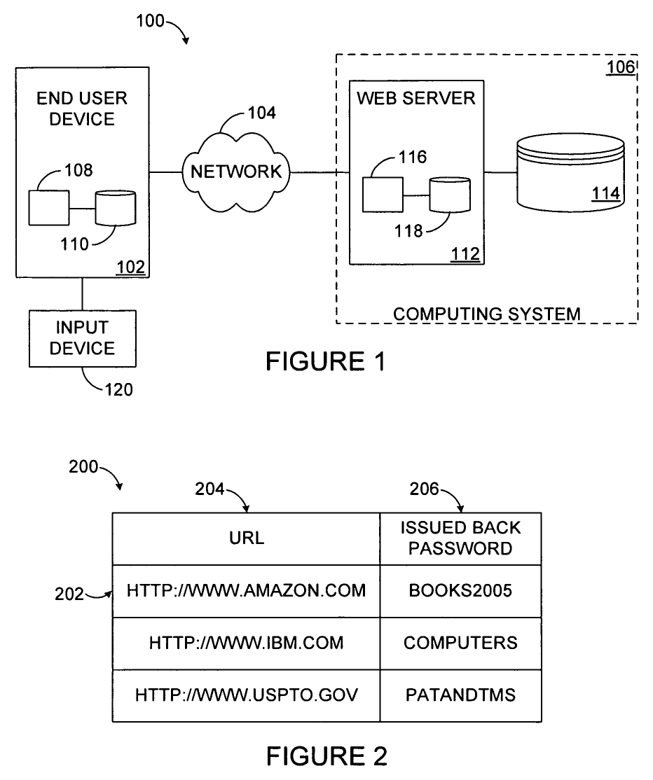

FIG. 1 illustrates an example computing or communication environment 100 according to one embodiment of this disclosure. The embodiment of the computing or communication environment 100 shown in FIG. 1 is for illustration only. Other embodiments of the computing or communication environment 100 could be used without departing from the scope of this disclosure.

In this example, the computing or communication environment 100 includes an end user device 102, a network 104, and a remote computing system 106. The end user device 102 represents a computing or communication device used by one or more users in the computing or communication environment 100. For example, the end user device 102 could represent a desktop computer, laptop computer, personal digital assistant, mobile telephone, or any other fixed or mobile computing or communication device. The end user device 102 is also capable of providing authentication information to a remote destination, such as by providing a username and password to the computing system 106 over the network 104. The authentication information allows a user of the end user device 102 to be authenticated by the computing system 106. The end user device 102 includes any hardware, software, firmware, or combination thereof allowing for communication and authentication with a remote computing system. As a particular example, the end user device 102 could include one or more processors 108 and one or more memories 110 capable of storing data and instructions used by the processors 108 (such as a random access memory, read-only memory, hard disk drive, CD drive, or DVD drive).

The network 104 is coupled to the end user device 102 and the computing system 106. The network 104 facilitates communication between various components in the computing or communication environment 100. For example, the network 104 may communicate Internet Protocol (IP) packets, frame relay frames, Asynchronous Transfer Mode (ATM) cells, or other suitable information between network addresses. The network 104 may include one or more public or private local area networks (LANs), metropolitan area networks (MANs), wide area networks (WANs), all or a portion of a global network such as the Internet, or any other wired or wireless communication system or systems at one or more locations.

The computing system 106 is coupled to the network 104. The computing system 106 represents any single computing device or combination of devices capable of providing any of a wide variety of functions in the computing or communication environment 100. For example, the computing system 106 could allow users to access information provided by a business or other organization. As a particular example, the computing system 106 could allow users to log onto the computing system 106 and order or pay for products or services from a business or other organization. Although described as a “remote” computing system, the computing system 106 may represent any suitable computing system that is separate from or external to the end user device 102 (no matter what the distance).

In this example, the computing system 106 includes a web server 112 and a database 114. The web server 112 facilitates access to the computing system 106 over the network 104 using a web browser. Among other things, the web server 112 could provide web pages that request authentication information (such as a username and password) to an end user device 102. In this way, the web server 112 may allow controlled access to the computing system 106. The web server 112 includes any hardware, software, firmware, or combination thereof providing web access to the computing system 106. As a particular example, the web server 112 could include one or more processors 116 and one or more memories 118 capable of storing data and instructions used by the processors 116.

The database 114 is coupled to the web server 112. The database 114 stores information used by the web server 112. For example, the database 114 could store information used by the web server 112 to generate web pages that are provided to the end user device 102 for display to a user. The database 114 could also store authentication information, such as usernames, passwords, and issued back passwords (discussed below). The web server 112 could compare at least some of the authentication information in the database 114 to authentication information received from an end user device 102. If the authentication information matches, the web server 112 could authenticate a user using the end user device 102. The database 114 includes any hardware, software, firmware, or combination thereof for storing and facilitating retrieval of information. The database 114 could also use any of a variety of data structures, arrangements, and compilations to store and facilitate retrieval of information.

In one aspect of operation, a user using the end user device 102 may access the computing system 106 and register with the computing system 106. This could include, for example, the web server 112 providing forms to the user, allowing the user to select a username and password. The username or password could be established in other ways. As an example, the web server 112 could send an electronic mail (email) message containing a username or provisional password to the user's email address, and the user could then log into the computing system 106 and change the username or password. The username or password could represent any suitable data, such as alphanumeric characters; a biometric, photographic, audio, video, or graphical file; or any other way of transporting biometric, photographic, audio, video, or graphical information through the network 104 using hardware, software, firmware, or a combination thereof.

During the registration process or at some other point in time, the computing system 106 sends an “issued back” password to the user. The issued back password is used to verify that a communication received by an end user device 102 originates from a legitimate source (such as the computing system 106 or an entity associated with the computing system 106). For example, if an email message is sent from the computing system 106 or from an entity associated with the computing system 106 to a user, the email message could include the issued back password. The user could then verify that the email message originated from the computing system 106 or a legitimate entity associated with the computing system 106 by determining whether the email message includes the issued back password. As another example, when a user logs into the computing system 106, the computing system 106 could respond by sending the issued back password to the user. In this way, the user can be sure that the user is logging into the actual computing system 106, rather than accessing a fraudulent website that appears to be associated with the computing system 106 but is not.

An issued back password may be unique to a particular user, or the issued back password could be generic to a group of users or all users. Also, the issued back password could be selected by a user or automatically selected by the computing system 106. In addition, the issued back password could represent biometric, photographic, textual, audio, graphical, video, or other information.

In some embodiments, the database 114 could store the usernames, passwords, and issued back passwords for various users authorized to access the computing system 106. Also, the web server 112 could access the database 114 and determine whether a user attempting to log onto the computing system 106 has provided a valid username or password. The web server 112 could provide the issued back password associated with a username/password combination to the end user device 102.

In some embodiments, the end user device 102 could track the issued back passwords provided by multiple computing systems 106. In particular embodiments, the issued back password for a particular computing system 106 or the issued back passwords for multiple computing systems 106 are displayed to the user when the user attempts to log onto a computing system 106, receives a communication allegedly from a computing system 106, upon a request from the user, or at any other time. The user could then, for example, determine if the computing system 106 responds with the correct issued back password or if a communication allegedly from a computing system 106 contains the correct issued back password. Further, the end user device 102 and the web server 112 could cooperate and allow a user to change the issued back password for the computing system 106, and the new issued back password could be tracked by the end user device 102.

In addition, an end user device 102 could maintain a database of issued back passwords and authenticate one or more computing systems 106. This authentication could be automatic and transparent to the user of the user device 102, or the user device 102 could acknowledge authentication of a computing system 106 automatically or upon being prompted by the user. The user device 102 could be programmed by a specific user to accept or reject communications based upon authentication, to specifically acknowledge whether authentication has been obtained or not, and/or to ignore the authentication process for communications with computing systems 106 using an issued back password. As a particular example, an end user device 102 could include an indicator (such as a visual or audio indicator) that informs the user whether a communication contains an expected issued back password.

In another aspect of operation, a user of the end user device 102 could provide biometric, photographic, audio, video, or graphical information to the computing system 106 during authentication. The information could include an image, such as a photograph of the user, an image of the user's eye, or some other graphical image. The information could also include a video file, an audio file, a voice sample, or a fingerprint. The web server 112 compares the received biometric, photographic, audio, video, or graphical information to biometric, photographic, audio, video, or graphical information stored in the database 114 and determines whether a match exists. If a match exists, the user may be authenticated. The biometric, photographic, audio, video, or graphical information could be used instead of or in addition to a password for the user.

In some embodiments, the biometric, photographic, audio, video, or graphical information provided by the user could be stored in the end user device 102, such as in the memory 110 of the end user device 102. In other embodiments, the biometric, photographic, audio, video, or graphical information could be captured using an input device 120. The input device 120 represents any hardware, software, firmware, or combination thereof for capturing biometric, photographic, audio, video, or graphical data. For example, the input device 120 could represent a camera, video camera, microphone, fingerprint scanner, retinal scanner, or other type of device.

Although FIG. 1 illustrates one example of a computing or communication environment 100, various changes may be made to FIG. 1. For example, the computing or communication environment 100 could include any number of end user devices 102, networks 104, and computing systems 106. Also, the input device 120 could be omitted from the computing or communication environment 100. Further, while a single database 114 is shown in FIG. 1, information may be stored in any suitable number of databases (such as when authentication information is stored in one database and product information is stored in a different database). In addition, FIG. 1 illustrates one example operational environment in which the different security mechanisms described above could operate. One or both security mechanisms could be used in other operational environments.

FIG. 2 illustrates an example issued back password table 200 according to one embodiment of this disclosure. The embodiment of the issued back password table 200 shown in FIG. 2 is for illustration only. Other embodiments of the issued back password table could be used without departing from the scope of this disclosure. Also, for ease of explanation, the issued back password table 200 of FIG. 2 is described as being used in the computing or communication environment 100 of FIG. 1. The issued back password table 200 could be used in any other suitable device, system, or environment.

In this example, the issued back password table 200 includes one or more entries 202, and each entry 202 includes a uniform resource locator (URL) 204 and an issued back password 206. The issued back password 206 in each entry 202 identifies the issued back password associated with the computing system accessed using the URL 204 in that entry 202.

When a user attempts to log into a computing system using a particular URL, the end user device 102 could access the issued back password table 200 and determine if any URLs 204 in the table 200 match the particular URL. If so, the end user device 102 could perform any suitable action. For example, the end user device 102 could receive an issued back password from the computing system that the user is accessing and compare the received password to the expected issued back password. The end user device 102 could then inform the user of the results (such as via an audio or visual indicator). The end user device 102 could also display the issued back password(s) 206 from the table 200 and allow the user to compare the received issued back password with the displayed issued back password(s) 206.

Although FIG. 2 illustrates one example of an issued back password table 200, various changes may be made to FIG. 2. For example, the issued back password table 200 could include any other or additional information according to particular needs. As a particular example, the issued back password table 200 need not only correlate issued back passwords with URLs. The issued back password table 200 may correlate issued back passwords with any other or additional identifier(s) for a computing or communication system or network (such as email address suffixes or other identifiers). Also, the information stored in the issued back password table 200 could be encrypted to protect the information from unauthorized access.

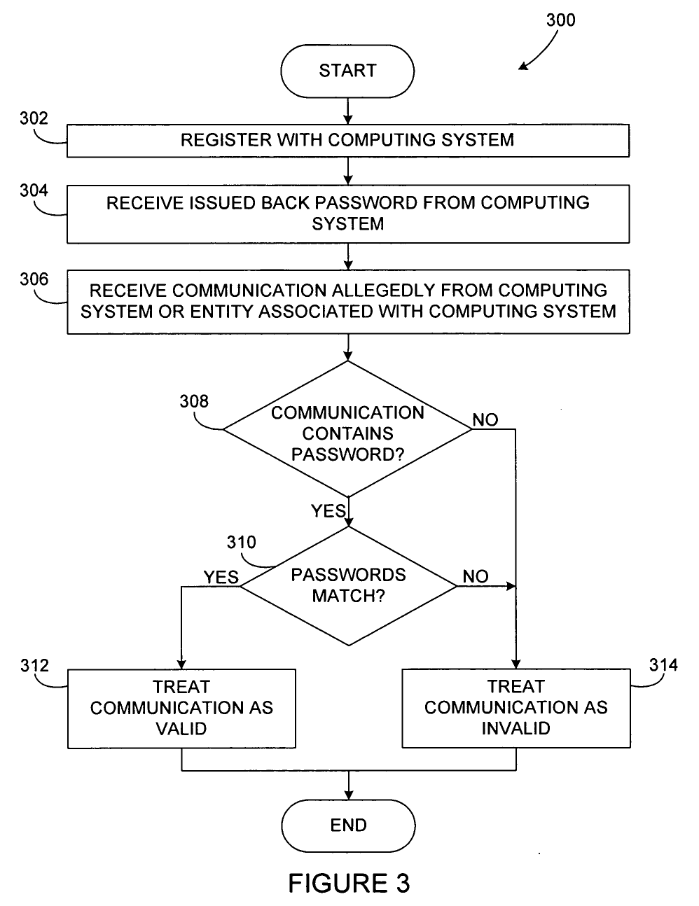

FIG. 3 illustrates an example method 300 for providing security using issued back passwords according to one embodiment of this disclosure. For ease of explanation, the method 300 of FIG. 3 is described with respect to the computing or communication environment 100 of FIG. 1. The method 300 could be used in any other suitable device, system, or environment.

A user using an end user device 102 registers with a computing system 106 at step 302. This may include, for example, the web server 112 providing the user with forms requesting various information from the user. This may also include the user providing the requested information. This may further include the user or the computing system 106 selecting a username and password for the user.

The user receives an issued back password from the computing system 106 at step 304. This may include, for example, the web server 112 automatically generating the issued back password, which may or may not be unique to the user. This may also include the web server 112 providing the issued back password to the user, such as by presenting the issued back password in a web page or sending an email message containing the issued back password to the user. This may further include the web server 112 allowing the user to select an issued back password.

At a later point in time, the user receives a communication that allegedly comes from the computing system 106 or an entity associated with the computing system 106 at step 306. The communication could represent an email message that appears to originate in the computing system 106. The communication could also represent a web page presented to the user as the user is logging into what appears to be the computing system 106. The communication could further represent a text message (such as an instant message) or any other type of communication between the end user device 102 and (allegedly) the computing system 106.

The user or the end user device 102 determines if the communication contains an issued back password at step 308. This may include, for example, the user examining the email message, text message, web page, or other communication to determine if the communication contains any issued back passwords.

If the communication contains an issued back password, the user or the end user device 102 compares the issued back password in the communication with the prior issued back password at step 310. This may include the end user device 102 accessing the issued back password table 200 of FIG. 2 to identify an expected issued back password. This may also include the end user device 102 displaying the expected issued back password to the user or automatically comparing the expected issued back password to the password in the communication and notifying the user of the results.

If the issued back passwords match, the communication is treated as valid at step 312. At this point, the user may believe to a higher degree of certainty that the communication originated from the computing system 106 or a legitimate entity associated with the computing system 106.

Otherwise, the communication is treated as invalid at step 314. At this point, the user may take any suitable action. For example, if the communication is an email message, the user could disregard the email message. If the communication is a web page presented as the user is logging into what appeared to be the computing system 106, the user could determine that he or she is communicating with an illegitimate computing system and take corrective action (such as changing the user's username or password with the legitimate computing system 106).

Although FIG. 3 illustrates one example of a method 300 for providing security using issued back passwords, various changes may be made to FIG. 3. For example, the issued back password could be received at some time other than when the user registers with a computing system 106. However, the issued back password should not be provided to a user until the computing system 106 properly verifies the user (such as through a username and password).

As another example, at step 312, the user device 102 or computing system 106 could necessitate going through additional login procedures or sequences. In some embodiments, the number of sequences of usernames, passwords, and/or issued back passwords could be more than one. For example, a user may access a computing system 106 with a username and password. Once the computing system 106 verifies the user, the computing system 106 may send the issued back password letting the user verify the legitimacy of the computing system 106. At this point, the computing system 106 could require that the user enter another username/password combination or just another password. The username and/or password could be the same as or different from the first username and/or password used. The computing system 106 could then submit the same or different issued back password to the user. The concept of entering/receiving multiple usernames, passwords, and/or issued back passwords (regardless if they are the same or different) could go on and on, stopping wherever the computing system 106 or the user chooses.

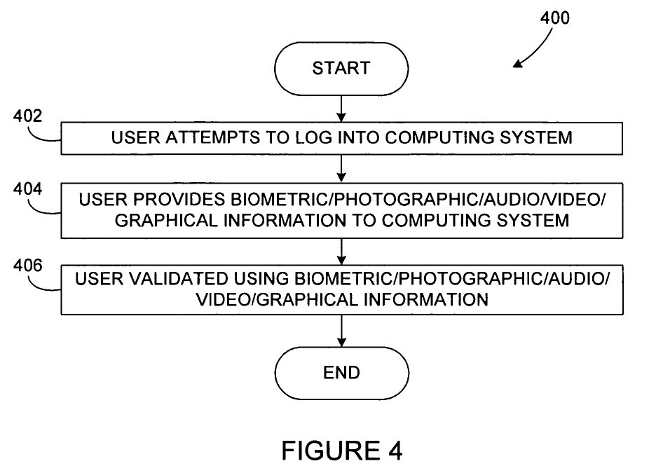

FIG. 4 illustrates an example method 400 for providing security using biometric, photographic, audio, video, or graphical security information according to one embodiment of this disclosure. For ease of explanation, the method 400 of FIG. 4 is described with respect to the computing or communication environment 100 of FIG. 1. The method 400 could be used in any other suitable device, system, or environment.

A user attempts to log into a computing system 106 at step 402. This may include, for example, the user using the end user device 102 to access a website and provide a username to the computing system 106 over the network 104.

The user provides biometric, photographic, audio, video, or graphical information to the computing system 106 at step 404. This may include, for example, the user using the input device 120 to generate new biometric, photographic, audio, video, or graphical information. This may also include the user selecting biometric, photographic, audio, video, or graphical information stored in the memory of the end user device 102. In particular embodiments, the end user device 102 could store multiple sets of biometric, photographic, audio, video, or graphical information, and the user could select the appropriate biometric, photographic, audio, video, or graphical information. The biometric, photographic, audio, video, or graphical information is provided to the computing system 106 over the network 104.

The computing system 106 authenticates or validates the user using the biometric, photographic, audio, video, or graphical information at step 406. This may include, for example, comparing a fingerprint or retinal scan of the user against an expected fingerprint or retinal scan. This could also include comparing a photograph of the user to an expected image. This could further include comparing any other biometric, photographic, audio, video, or graphical file or other information to expected information to verify whether the user attempting to access the computing system 106 is authorized.

Although FIG. 4 illustrates one example of a method 400 for providing security using biometric, photographic, audio, video, or graphical security information, various changes may be made to FIG. 4. For example, the user could be validated using information other than the biometric, photographic, audio, video, or graphical security information, such as when the user also provides a text password to the computing system 106.

It may be advantageous to set forth definitions of certain words and phrases that have been used within this patent document. The phrase “issued back password” and its derivatives refer to any alphanumeric, textual, biometric, photographic, audio, video, graphical, or other security information or any combination thereof. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, software, firmware, or combination thereof. It should be noted that the functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method, comprising:
receiving an issued back password from a computing or communication system; and
using the issued back password to verify a communication with the computing or communication system.

2. The method of claim 1, wherein using the issued back password to verify the communication with the computing or communication system comprises:
receiving a message that appears to originate with at least one of: the computing or communication system and an entity associated with the computing or communication system; and
verifying whether the message contains the issued back password.

3. The method of claim 2, wherein the message comprises at least one of: an electronic mail message and a text message.

4. The method of claim 1, wherein using the issued back password to verify the communication with the computing or communication system comprises:
attempting to log into the computing or communication system; and
verifying whether the issued back password is received from the computing or communication system during or after the login process.

5. The method of claim 1, further comprising selecting the issued back password prior to using the issued back password to verify the communication with the computing or communication system.

6. The method of claim 1, wherein using the issued back password to verify the communication with the computing or communication system comprises using an issued back password table, the table comprising a plurality of entries, each entry comprising:
an issued back password; and
an identifier identifying one of a plurality of computing or communication systems associated with the issued back password.

7. The method of claim 6, wherein the identifier comprises at least one of: a Uniform Resource Locator (URL) and an electronic mail suffix.

8. The method of claim 6, wherein using the issued back password to verify the communication with the computing or communication system comprises:
selecting one of the entries in the table; and
notifying the user whether the issued back password in the selected entry in the table matches a received issued back password associated with the communication.

9. An apparatus, comprising:
at least one memory operable to store authentication information associated with a user, the authentication information comprising an issued back password; and
at least one processor operable to:
transmit a communication to a computing or communication device used by the user; and
include the issued back password in the communication.

10. The apparatus of claim 9, wherein:
the communication comprises a message; and
the issued back password in the message facilitates verification by the user that the message originated with at least one of: a specified computing or communication system and an entity associated with the specified computing or communication system.

11. The apparatus of claim 9, wherein:
the communication comprises one or more web pages; and
the issued back password in the one or more web pages facilitates verification by the user that the one or more web pages originated with a specified computing or communication system.

12. The apparatus of claim 9, wherein the at least one processor is further operable to allow the user to select the issued back password.

13. The apparatus of claim 9, wherein:
the authentication information further comprises a username and a password associated with the user; and
the at least one processor is further operable to authenticate the user using the username and password.

14. A method, comprising:
storing authentication information associated with a user of a computing or communication system, the authentication information comprising an issued back password; and
transmitting a communication to a computing or communication device used by the user, the communication including the issued back password.

15. The method of claim 14, wherein:
the communication comprises a message; and
the issued back password in the message facilitates verification by the user that the message originated with at least one of: the computing or communication system and an entity associated with the computing or communication system.

16. The method of claim 14, wherein:
the communication comprises one or more web pages; and
the issued back password in the one or more web pages facilitates verification by the user that the one or more web pages originated with the computing or communication system.

17. The method of claim 14, further comprising allowing the user to select the issued back password.

18. The method of claim 17, wherein allowing the user to select the issued back password comprises allowing the user to select the issued back password while the user is initially registering with the computing or communication system.

19. An apparatus, comprising:
at least one memory operable to store authentication information, the authentication information comprising an issued back password for each of a plurality of computing or communication systems; and
at least one processor operable to:
receive a communication that appears to originate with at least one of: a specified one of the computing or communication systems and an entity associated with the specified computing or communication system; and
notify a user whether an issued back password associated with the communication matches the issued back password associated with the specified computing or communication system contained in the at least one memory.

20. The apparatus of claim 19, wherein the authentication information comprises an issued back password table, the table comprising a plurality of entries, each entry comprising:
an issued back password; and
an identifier identifying the computing or communication system associated with the issued back password.

21. The apparatus of claim 19, wherein the communication comprises a message that appears to originate with at least one of: the specified computing or communication system and an entity associated with the specified computing or communication system.

22. The apparatus of claim 19, wherein the communication comprises one or more web pages associated with an attempted login to the specified computing or communication system.

23. The apparatus of claim 19, further comprising at least one of: an audio indicator and a visual indicator, the at least one processor operable to use the at least one indicator to notify the user whether the issued back password associated with the communication matches the issued back password associated with the specified computing or communication system.

24. A computer program embodied on a computer readable medium and operable to be executed by a processor, the computer program comprising computer readable program code for:
receiving an issued back password from a computing or communication system; and
using the issued back password to verify a communication with the computing or communication system.

25. A computer program embodied on a computer readable medium and operable to be executed by a processor, the computer program comprising computer readable program code for:
storing authentication information associated with a user of a computing or communication system, the authentication information comprising an issued back password; and
transmitting a communication to a computing or communication device used by the user, the communication including the issued back password.

26. A method, comprising:
providing authentication information to a computing or communication system, the authentication information comprising a username and password;
receiving an issued back password from the computing or communication system;
verifying whether the issued back password matches an expected issued back password; and
providing additional authentication information to the computing or communication system if the issued back password matches the expected issued back password.

27. A method, comprising:
providing at least one of biometric information, photographic information, audio information, video information, and graphical information to a computing or communication system over a network to gain access to the computing or communication system.
